(19) United States
(12) Patent Application Publication
(10) Pub. No.: US 2010/0136181 A1
(43) Pub. Date: Jun. 3, 2010

(54) PARTICULATE FOOD COMPONENT

(75) Inventors: Karin Eggenreich, Weiz (AT); Frederic Hariot, Paris (FR); Martin Ulreich, Pinkafeld (AT)

Correspondence Address: LOWE HAUPTMAN HAM & BERNER, LLP, 1700 DIAGONAL ROAD, SUITE 300, ALEXANDRIA, VA, 22314, US

(73) Assignee: ARGANA BETEILIGUNGS-AKTIENGESELLSCHAFT, WIEN (AT)

(21) Appl. No.: 12/596,001

(22) PCT Filed: Apr. 23, 2008
(86) PCT No.: PCT/AT08/00148

§ 371 Date: Nov. 23, 2009

(30) Foreign Application Priority Data
Apr. 23, 2007 (AT) A 630/2007

(51) Int. Cl. A23L 1/00

(52) U.S. Cl. 426/89; 426/289

(57) ABSTRACT

The invention relates to a particulate food constituent comprising a filling and a coating, characterised in that the filling is a food preparation which is free-flowing at room temperature and selected from the group consisting of fruit preparations, other preparations and mixtures thereof, and in that the coating consists of a layer consisting of a constituent selected from the group of suitable cocoa products, chocolate products, and hydrophobic food ingredients, especially optionally aromatised and/or dyed fats or fatty materials that have a minimum fat content of 80%, or mixtures thereof. The average particle diameter of the food constituent is between 6 and 18 mm, preferably between 8 and 11 nm.

### CROSS-REFERENCE TO RELATED APPLICATIONS

The present Application is based on International Application No. PCT/AT08/000148, filed on Apr. 23, 2008, which in turn corresponds to Austrian Application No. A630/2007, filed on Apr. 23, 2007, and priority is hereby claimed under 35 USC §119 based on these applications. Each of these applications are hereby incorporated by reference in their entirety into the present application.

### FIELD OF THE INVENTION

The present invention relates to a particulate food component which is suitable for being mixed into a milk product such as, e.g., yoghurt or curd creams.

### BACKGROUND OF THE INVENTION

It is known to mix particulate food components, e.g., cereal particles or chocolate particles, into food, in particular milk products, for improving the taste and/or for changing the texture (by using crisp particles).

From GB 1,120,956, freeze-dried fresh fruits or fruit purees are known which can also be used as a component of a food, e.g., a chocolate bar.

JP-A 2004-357647 describes the coating of raw fruits with chocolate. JP-A 2006-141230 is also based on raw fruits (Ume fruits) which are coated with different components (liqueur, chocolate).

SU 1729396 as well as RU 2067838, describe the coating of fruit purees and the like with a chocolate layer. The fruit purees used as a starting product are gelatinous, i.e., they are not flowable at room temperature.

Thus, all the above-mentioned printed publications describe food components whose fillings (fruits or fruit purees) are present in solid form upon consumption.

Further processes for the coating of particles, e.g., food components, are described in US 2004/131730 A1 and GB 2,186,542.

According to at least one embodiment of the present invention, a particulate food component comprising a filling and a coating is provided. The filling is a food preparation flowable at room temperature and is selected from fruit preparations or mixtures thereof. The coating has a layer of a component selected from at least one of food grade cocoa products, chocolate products and food ingredients with a hydrophobic activity, in particular optionally flavoured and/or coloured food grade fats or fat-containing materials with a fat content of 80% or more, and mixtures thereof. The average particle diameter of the particulate component ranges from 6 to 18 mm, and preferably from 8 to 11 mm.

For the purposes of the present invention, the terms fruit preparation and mixtures thereof denote the products defined in the Österreichisches Lebensmittelbuch [Austrian Food Codex] (Codex Alimentarius Austriacus) Delivery 55, January 2007, Paragraph B 32, TK “Mixed Milk Products”, Appendices I. and II.

In particular, a fruit preparation contained in the food component according to at least one embodiment of the invention, can be selected from fruit juices, fruit juice concentrates and optionally sieved fruit purees, in particular banana puree, wood berry puree, coconut puree, mango puree, sieved strawberries and mixtures thereof.

A further preparation contained in the food component can be selected from preparations of honey, hard-shelled fruits, cocoa, low-fat cocoa, chocolate, coffee and vanilla.

Thus, the food component according to the invention, differs from the products of the prior art in that the filling which is contained (fruit preparation or further preparation) is flowable at room temperature. This produces a sensory impression which is pleasant and, respectively, in combination with a solid coating, also “surprising”.

The food preparation used in the food component according to at least one embodiment of the invention preferably has a viscosity at room temperature of from 0.1 Pa.s to 100 Pa.s.

The filling of the food component may essentially be the food preparation. This is to say, apart from the food preparation and insignificant amounts of auxiliary agents such as pectin, no further ingredients or substances are contained in the filling. Gelling auxiliary agents such as pectin are contained only in an amount below that which would result in a solidification of the food preparation at room temperature.

The coating may consist of a single layer, and is, in a particular embodiment, a chocolate layer.

Alternatively, the coating may comprise two or several layers of components which optionally are different. For example, the coating may comprise an inner layer of cocoa products or chocolate products and an outer layer of food grade fats or fat-containing materials.

The food component according to embodiments of the invention can be present in the form of essentially spherical particles. In particular when the food component is used in a milk product, it is important that the food component is essentially aseptic.

Therefore, the food component according to the invention is preferably present in an essentially sterile form. In particular, the food component should be completely free from yeast or mould and should exhibit a total bacterial count of less than 100 germs/g.

The present invention also relates to a food which contains an embodiment of the above-mentioned food component. The food is preferably selected from milk products, in particular yoghurts, curd creams, rice pudding, pudding and whey products.

The combination of a food component with a liquid filling and an essentially hard coating (e.g., a chocolate layer) with a milk product from the group of the aforementioned products results in a food which is very appealing in taste and also in sensory terms.

A further aspect of the invention resides in the process of

a) forming a food preparation flowable at room temperature into the desired shape of a filling;

b) covering the formed food preparation with the material of the coating.

It should be noted that the forming of the food preparation and covering it with the material of the coating can, for example, be carried out in a single step according to the so-called One-shot technology. One-shot technology is a technique which allows the production of filled products in one casting step. In doing so, the products are cast into moulds made, e.g., of silicone or polycarbonate.

In an alternative embodiment, the food preparation is deep-frozen prior to step b), optionally simultaneously with step a). In step a), the food preparation can, in particular, be dropped onto a cooled surface and be deep-frozen on the surface while solidifying. A frozen particle formed in situ, which in particular is ball-shaped, is thereby formed and can be covered with the material of the coating in a further step b).

In step b), the material of the coating can be applied to the formed food preparation in particular by one or several of the following variants:

i) spraying onto the formed food preparation;

ii) pouring the material of the coating over the formed food preparation; and

iii) dipping the formed food preparation into the material of the coating.

Step b) can thereby be carried out several times either in order to obtain several layers of different materials or in order to thicken an existing layer. Between two steps b), the formed food preparation can be turned around, in particular if it is present in the form of frozen particles. Thereby, all sides of the food preparation can be coated in the course of several application steps b). Alternatively, the material of the coating can be applied to the food preparation from several sides (e.g., from above and from below) in one or several steps.

The material of the coating can be applied to the food preparation in a suitable temperature range known per se to a person skilled in the art. If, for example, chocolate is used as the material of the coating, the chocolate can be applied at temperatures ranging from 25° C. to 80° C.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE FIGURE

The present invention is illustrated by way of example, and not by limitation, in the figures of the accompanying drawings, wherein elements having the same reference numeral designations represent like elements throughout and wherein:

FIG. 1, which is the sole FIGURE, schematically depicts a preferred device for producing the food component according to an embodiment of the invention.

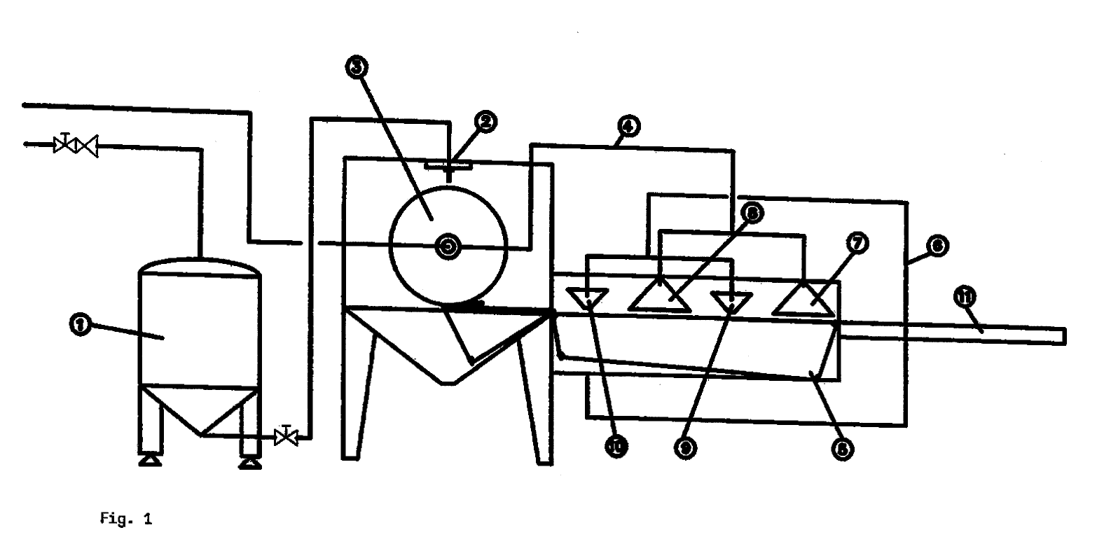

### DETAILED DESCRIPTION OF THE EMBODIMENTS OF THE INVENTION

A food preparation (e.g., a fruit preparation) is provided in a receiver container 1. Via a pipe, the food preparation is supplied to the device 2, where it is applied to a drum 3, which has been cooled by means of a cooling pipe 4.

The temperature of the drum may reach minus 100° C. in the interior and minus 50° C. on the surface. By contacting the food preparation with the cooled surface, the preparations flowable at room temperature, become deep-frozen.

The frozen particles are then scraped from the drum 3 using a scraper (not illustrated) and are transferred onto a conveyor belt 11 which conveys the particles into a device 5 for covering the particles with a coating.

In the device 5, the particles are covered alternately by means of the devices 9 and 10 with a coating material supplied through a pipe 6 and are cooled by means of the cooling devices 7 and 8, which are fed through the cooling pipe 4. The coating material is circulated through the pipe 6.

### EXAMPLES

### 1) One-Shot Technology

A standard laboratory casting plant (pilot plant), which can be used for casting jelly articles (starch, pectin, gelatine) as well as for producing one-shot products, was employed.

### Raw Materials Used:

### Coating:

Standard milk chocolate, product temperature of 30° C. during casting

### Filling:

a) Banana puree spiked with flavours and 1% potassium sorbate (viscosity 0.8 Pa.s)

b) Strawberry sieved with 3% starch cold-swelling, spiked with 1% potassium sorbate (for preservation) and flavours, product temperature of 27° C. during casting (viscosity approx. 1.1 Pa.s).

Hemispheres were produced from the material of the coating and the material of the filling, which can be put together to form balls. The trials were run with a ratio of coating to filling of 50:50 and 70:30.

Particles having a diameter of 12 mm (˜0.4 g) and 18 mm (˜0.9 g), respectively, were produced. The layer thickness of the chocolate layer was 1-2 mm.

2) Production with a Frozen Filling Material

An aseptic mango puree (viscosity at room temperature: 0.3 Pa.s) was used for producing the frozen cores.

Using a pump, the puree was dropped onto the surface of a cryodrum, where it froze. Subsequently, the cores which had formed were scrapped off and collected via a funnel.

The temperature of the cores immediately after the production amounted to minus 40° C.

Two types of dark chocolate were used for coating:
1. A semisweet dark chocolate coating;
2. A standard dark chocolate coating.

The cores produced were applied to a grid band in the still deep-frozen state and chocolate (temperature at 78° C.) was sprayed thereon immediately after the application. Optionally, chocolate was also applied from below the grid band by means of a roll.

Via a heated roll, the coated particles were applied to a second grid band, which was in a lower position, resulting in a change in the orientation of the particles. On the second grid band, a second coating step with chocolate was carried out, using a spraying system or a chocolate curtain. The coated particles, which had a diameter of approx. 8 mm and a weight of approx. 0.25 g, were transferred onto a conveyor belt, cooled and either transferred into a storage container or introduced directly into a fruit preparation or a milk product.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A particulate food component comprising:
a filling; and
a coating,
wherein the filling is a food preparation flowable at room temperature and which is selected from the group of fruit preparations and mixtures thereof,
wherein the coating has a layer selected from the group of food grade cocoa products, chocolate products and food ingredients with hydrophobic activity, in particular optionally flavoured and/or coloured food grade fats or fat-containing materials with a fat content of 80% or more, and mixtures thereof, respectively, and wherein the average particle diameter of the food component ranges from 6 to 18 mm, preferably from 8 to 11 mm.

2. The food component according to claim 1, wherein the food preparation is a fruit preparation selected from fruit juices, fruit juice concentrates and optionally sieved fruit purees, in particular banana puree, wood berry puree, coconut puree, mango puree, sieved strawberries or mixtures thereof.

3. The food component according to claim 1 wherein the food preparation is a further preparation selected from preparations of honey, hard-shelled fruits, cocoa, low-fat cocoa, chocolate, coffee or vanilla.

4. The food component according to claim 1, wherein the food preparation has a viscosity at room temperature of from 0.1 Pa.s to 100 Pa.s.

5. A food component according to claim 1, wherein the filling essentially is the food preparation.

6. The food component according to claim 5, wherein the coating comprises a single layer.

7. The food component according to claim 5, wherein the coating comprises two or several layers of components which optionally are different.

8. The food component according to claim 7, wherein the coating comprises an inner layer of cocoa products or chocolate products and an outer layer of food grade fats or fat-containing materials.

9. The food component according to claim 1, wherein it comprises essentially spherical particles.

10. The food component according to claim 1, wherein it is in an essentially sterile form.

11. A food which contains a food component according to claim 1.

12. The food according to claim 11 in the form of a product selected from milk products, comprising yoghurts, curd creams, rice pudding, pudding and whey products.

13. A process for producing a food component according to claim 1, comprising the steps of:
a) forming a food preparation flowable at room temperature into the desired shape of a filling; and
b) covering the formed food preparation with the material of the coating.

14. The process according to claim 13, wherein the food preparation is deep-frozen prior to step b), or simultaneously with step a).

15. A process according to claim 13, wherein, in step b), the material of the coating is applied to the formed food preparation by one or more of:
i) spraying onto the formed food preparation; and
ii) pouring the material of the coating over the formed food preparation; and
iii) dipping the formed food preparation into the material of the coating.

16. The process according to claim 13, wherein step b) is carried out several times.

17. The process according to claim 16, wherein the formed food preparation is turned around between two steps b).

18. The process according to claim 13, wherein, in step a), the food preparation is dropped onto a cooled surface and is deep-frozen on the surface while solidifying.
